(19) United States
(12) Patent Application Publication
(10) Pub. No.: US 2026/0058894 A1
(43) Pub. Date: Feb. 26, 2026

(54) QUALITY-OF-SERVICE MONITORING IN CONTENT DISTRIBUTION NETWORKS

(71) Applicant: Cisco Technology, Inc., San Jose, CA (US)

(72) Inventors: Xiao Zhang, Durham, NC (US); Arash Molavi Kakhki, San Francisco, CA (US); Rinaldo Buratti, San Francisco, CA (US)

(73) Assignee: Cisco Technology, Inc., San Jose, CA (US)

(21) Appl. No.: 18/811,105

(22) Filed: Aug. 21, 2024

(51) Int. Cl. H04L 43/12; H04L 41/0631; H04L 41/22

(52) U.S. Cl. CPC H04L 43/12; H04L 41/0631; H04L 41/22

(57) ABSTRACT

In one implementation, a device may make a determination that a response to a network test probe includes content from a node of a content delivery network. The device extracts, based on the determination, performance data for the content delivery network from a header and from side-channel data collected associated with the response. The device generates, based on the performance data, a performance characterization for the content delivery network. The device provides the performance characterization for the content delivery network to a user interface for review.

### TECHNICAL FIELD

The present disclosure relates generally to computer networks and more particularly to quality-of-service monitoring in content distribution networks.

### BACKGROUND

As a crucial part of modern Internet infrastructure, content distribution networks (CDNs) act as the last mile to deliver resources (e.g., images, videos, or other similar static resources) to the endpoint clients. Often deployed globally across hundreds or even thousands of cities around the world, a CDN allows the endpoint to retrieve such resources from a nearby CDN server, rather than requiring it to do so via the server of a webpage provider.

However, it can also be difficult to ascertain how well a CDN is working as they largely operate as block boxes, with limited visibility into their internal mechanisms and/or performance. For instance, while it may be useful to determine whether an endpoint is utilizing the closest server to download the resource in order to assess a CDN's performance from the perspective of the endpoint, there is currently no mechanism to provide this visibility. Likewise, there are no existing mechanisms capable of providing visibility to an origin server, to determine how many CDN servers actually cached its resources and/or how to distribute its resources to the users.

This opacity obscures CDN-related failures that significantly impact user experience. For example, lack of visibility to identify cache inefficiencies can lead to unnecessary latency, lack of visibility to identify geographic load imbalances can cause server overloads, and/or lack of visibility to identify unresolved routing inefficiencies can increase round-trip times.

### BRIEF DESCRIPTION OF THE DRAWINGS

The implementations herein may be better understood by referring to the following description in conjunction with the accompanying drawings in which like reference numerals indicate identically or functionally similar elements, of which:

FIG. 1 illustrates an example computer network;

FIG. 2 illustrates an example computing device/node;

FIG. 3 illustrates an example observability intelligence platform;

FIG. 4 illustrates an example of an architecture for quality-of-service monitoring in content distribution networks;

FIG. 5 illustrates an example of a mapping of observability intelligence platform agents and the CDN server locations discovered by those observability intelligence platform agents;

FIG. 6 illustrates an example of a performance mapping of observability intelligence platform agents downloading web pages from a content deliver network server;

FIG. 7 illustrates an example of a cache hit rate graph;

FIG. 8 illustrates an example of a round-trip time graph for a CDN server;

FIG. 9 illustrates an example of an agent-to-CDN server access geographical distribution chart; and

FIG. 10 illustrates an example of a simplified procedure for quality-of-service monitoring in content distribution networks, in accordance with one or more implementations described herein.

### DESCRIPTION OF EXAMPLE IMPLEMENTATIONS

### Overview

According to one or more implementations of the disclosure, a device may make a determination that a response to a network test probe includes content from a node of a content delivery network. The device extracts, based on the determination, performance data for the content delivery network from a header and from side-channel data collected associated with the response. The device generates, based on the performance data, a performance characterization for the content delivery network. The device provides the performance characterization for the content delivery network to a user interface for review.

Other implementations are described below, and this overview is not meant to limit the scope of the present disclosure.

### Description

A computer network is a geographically distributed collection of nodes interconnected by communication links and segments for transporting data between end nodes, such as personal computers and workstations, or other devices, such as sensors, etc. Many types of networks are available, ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, and others. The Internet is an example of a WAN that connects disparate networks throughout the world, providing global communication between nodes on various networks. Other types of networks, such as field area networks (FANs), neighborhood area networks (NANs), personal area networks (PANs), enterprise networks, etc. may also make up the components of any given computer network. In addition, a Mobile Ad-Hoc Network (MANET) is a kind of wireless ad-hoc network, which is generally considered a self-configuring network of mobile routers (and associated hosts) connected by wireless links, the union of which forms an arbitrary topology.

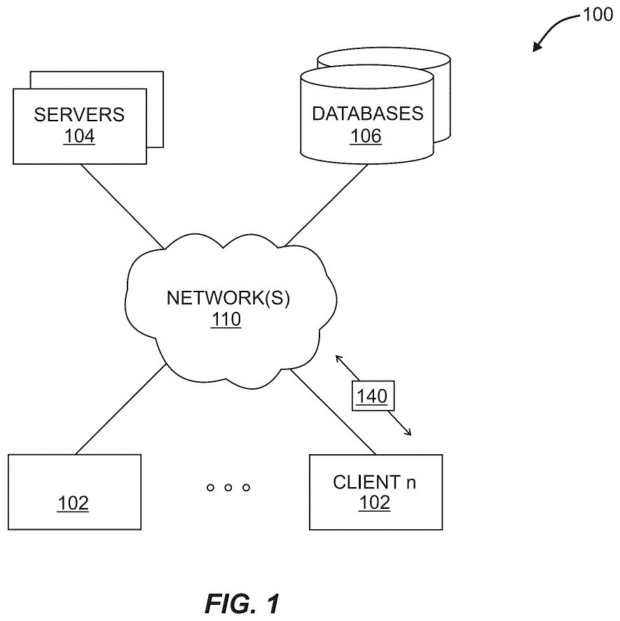

FIG. 1 is a schematic block diagram of an example simplified computing system (e.g., the computing system 100), which includes client devices 102 (e.g., a first through nth client device), one or more servers 104, and databases 106 (e.g., one or more databases), where the devices may be in communication with one another via any number of networks (e.g., network(s) 110). The network(s) 110 may include, as would be appreciated, any number of specialized networking devices such as routers, switches, access points, etc., interconnected via wired and/or wireless connections. For example, client devices 102, the one or more servers 104 and/or the intermediary devices in network(s) 110 may communicate wirelessly via links based on WiFi, cellular, infrared, radio, near-field communication, satellite, or the like. Other such connections may use hardwired links, e.g., Ethernet, fiber optic, etc. The nodes/devices typically communicate over the network by exchanging discrete frames or packets of data (packets 140) according to predefined protocols, such as the Transmission Control Protocol/Internet Protocol (TCP/IP) other suitable data structures, protocols, and/or signals. In this context, a protocol consists of a set of rules defining how the nodes interact with each other.

Client devices 102 may include any number of user devices or end point devices configured to interface with the techniques herein. For example, client devices 102 may include, but are not limited to, desktop computers, laptop computers, tablet devices, smart phones, wearable devices (e.g., heads up devices, smart watches, etc.), set-top devices, smart televisions, Internet of Things (IoT) devices, autonomous devices, or any other form of computing device capable of participating with other devices via network(s) 110.

Notably, in some implementations, the one or more servers 104 and/or databases 106, including any number of other suitable devices (e.g., firewalls, gateways, and so on) may be part of a cloud-based service. In such cases, the servers and/or databases 106 may represent the cloud-based device(s) that provide certain services described herein, and may be distributed, localized (e.g., on the premise of an enterprise, or “on prem”), or any combination of suitable configurations, as will be understood in the art.

Those skilled in the art will also understand that any number of nodes, devices, links, etc. may be used in computing system 100, and that the view shown herein is for simplicity. Also, those skilled in the art will further understand that while the network is shown in a certain orientation, the computing system 100 is merely an example illustration that is not meant to limit the disclosure.

Notably, web services can be used to provide communications between electronic and/or computing devices over a network, such as the Internet. A web site is an example of a type of web service. A web site is typically a set of related web pages that can be served from a web domain. A web site can be hosted on a web server. A publicly accessible web site can generally be accessed via a network, such as the Internet. The publicly accessible collection of web sites is generally referred to as the World Wide Web (WWW).

Also, cloud computing generally refers to the use of computing resources (e.g., hardware and software) that are delivered as a service over a network (e.g., typically, the Internet). Cloud computing includes using remote services to provide a user's data, software, and computation.

Moreover, distributed applications can generally be delivered using cloud computing techniques. For example, distributed applications can be provided using a cloud computing model, in which users are provided access to application software and databases over a network. The cloud providers generally manage the infrastructure and platforms (e.g., servers/appliances) on which the applications are executed. Various types of distributed applications can be provided as a cloud service or as a Software as a Service (SaaS) over a network, such as the Internet.

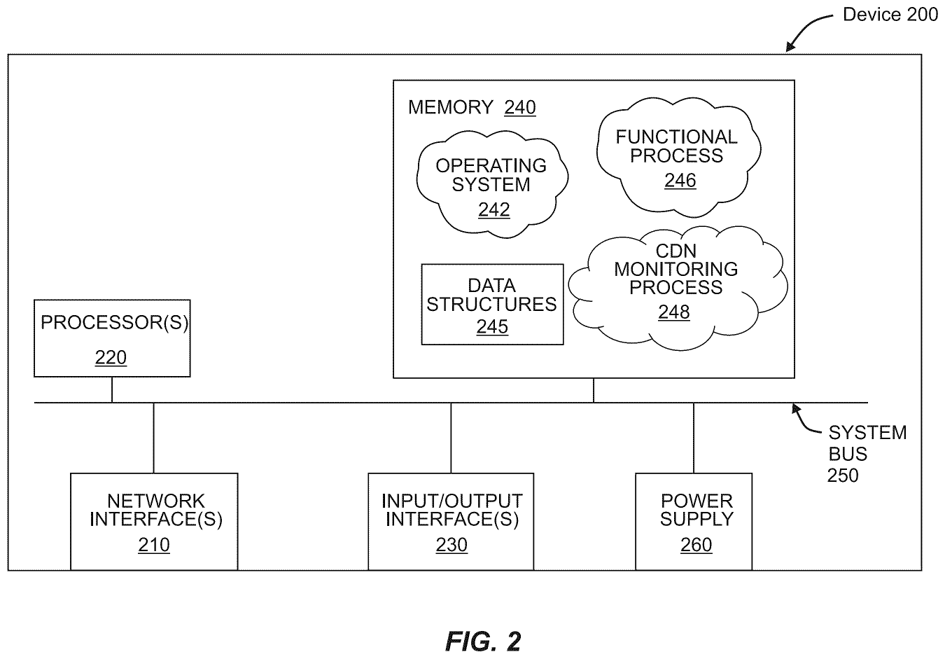

FIG. 2 is a schematic block diagram of an example node/device 200 (e.g., an apparatus) that may be used with one or more implementations described herein, e.g., as any of the devices shown in FIG. 1 above. Device 200 may comprise one or more network interfaces, such as interfaces 210 (e.g., wired, wireless, network interfaces, etc.), at least one processor (e.g., processor 220), and a memory 240 interconnected by a system bus 250, as well as a power supply 260 (e.g., battery, plug-in, etc.).

The interfaces 210 contain the mechanical, electrical, and signaling circuitry for communicating data over links coupled to the network(s) 110. The network interfaces may be configured to transmit and/or receive data using a variety of different communication protocols. Note, further, that device 200 may have multiple types of network connections via interfaces 210, e.g., wireless and wired/physical connections, and that the view herein is merely for illustration.

Depending on the type of device, other interfaces, such as input/output (I/O) interfaces 230, user interfaces (UIs), and so on, may also be present on the device. Input devices, in particular, may include an alpha-numeric keypad (e.g., a keyboard) for inputting alpha-numeric and other information, a pointing device (e.g., a mouse, a trackball, stylus, or cursor direction keys), a touchscreen, a microphone, a camera, and so on. Additionally, output devices may include speakers, printers, particular network interfaces, monitors, etc.

The memory 240 comprises a plurality of storage locations that are addressable by the processor 220 and the interfaces 210 for storing software programs and data structures associated with the implementations described herein. The processor 220 may comprise hardware elements or hardware logic adapted to execute the software programs and manipulate the data structures 245. An operating system 242, portions of which are typically resident in memory 240 and executed by the processor, functionally organizes the device by, among other things, invoking operations in support of software processes and/or services executing on the device. These software processes and/or services may comprise a one or more functional processes (e.g., functional processes 246), and on certain devices, an illustrative process such as CDN monitoring process 248, as described herein. Notably, functional processes 246, when executed by processor 220, cause each device 200 to perform the various functions corresponding to the particular device's purpose and general configuration. For example, a router would be configured to operate as a router, a server would be configured to operate as a server, an access point (or gateway) would be configured to operate as an access point (or gateway), a client device would be configured to operate as a client device, and so on.

It will be apparent to those skilled in the art that other processor and memory types, including various computer-readable media, may be used to store and execute program instructions pertaining to the techniques described herein. Also, while the description illustrates various processes, it is expressly contemplated that various processes may be implemented as modules configured to operate in accordance with the techniques herein (e.g., according to the functionality of a similar process). Further, while processes may be shown and/or described separately, those skilled in the art will appreciate that processes may be routines or modules within other processes.

In various implementations, as detailed further below, CDN monitoring process 248 may include computer executable instructions that, when executed by processor 220, cause device 200 to perform the techniques described herein. To do so, in some implementations, CDN monitoring process 248 may utilize and/or be a component of machine learning implementations. In general, machine learning is concerned with the design and the development of techniques that take as input empirical data (such as network statistics and performance indicators) and recognize complex patterns in these data. One very common pattern among machine learning techniques is the use of an underlying model M, whose parameters are optimized for minimizing the cost function associated to M, given the input data. For instance, in the context of classification, the model M may be a straight line that separates the data into two classes (e.g., labels) such that M=a*x+b*y+c and the cost function would be the number of misclassified points. The learning process then operates by adjusting the parameters a, b, c such that the number of misclassified points is minimal. After this optimization phase (or learning phase), the model M can be used very easily to classify new data points. Often, M is a statistical model, and the cost function is inversely proportional to the likelihood of M, given the input data.

In various implementations, CDN monitoring process 248 may employ and/or be utilized to handle prompts to and/or access of one or more supervised, unsupervised, or semi-supervised machine learning models. CDN monitoring process 248 may employ and/or be utilized to handle prompts to and/or access of one or more supervised, unsupervised, or semi-supervised machine learning models trained to identify CDN performance metrics and/or operationally map CDNs. Generally, supervised learning entails the use of a training set of data that is used to train the model to apply labels to the input data. For example, the training data may include sample configurations labeled with textual metadata. On the other end of the spectrum are unsupervised techniques that do not require a training set of labels. Notably, while a supervised learning model may look for previously seen patterns that have been labeled as such, an unsupervised model may instead look to whether there are sudden changes or patterns in the behavior of the metrics. Semi-supervised learning models take a middle ground approach that uses a greatly reduced set of labeled training data.

Example machine learning techniques that CDN monitoring process 248 can employ and/or be utilized in concert with may include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), generative adversarial networks (GANs), long short-term memory (LSTM), logistic or other regression, Markov models or chains, principal component analysis (PCA) (e.g., for linear models), singular value decomposition (SVD), multi-layer perceptron (MLP) artificial neural networks (ANNs) (e.g., for non-linear models), replicating reservoir networks (e.g., for non-linear models, typically for timeseries), random forest classification, or the like.

In further implementations, CDN monitoring process 248 may also include, or otherwise use or be employed to operate with, one or more generative artificial intelligence/machine learning models. In contrast to discriminative models that simply seek to perform pattern matching for purposes such as anomaly detection, classification, or the like, generative approaches instead seek to generate new content or other data (e.g., audio, video/images, text, etc.), based on an existing body of training data. For instance, in the context of configuring an observability platform to perform certain application analytics, CDN monitoring process 248 may be a component of, use, and/or be utilized in the management of prompts/access to a generative model to generate configurations or other outputs based on a conversational input from a user (e.g., voice, text, etc.). In another example, CDN monitoring process 248 may utilize a generative model with a method invocation data collector (MIDC) to assist in automated or manual identification of transactional attributes for spans. In yet another example, CDN monitoring process 248 may be utilize a generative model to identify CDN performance metrics and/or operationally map CDNs. Example generative approaches can include, but are not limited to, generative adversarial networks (GANs), large language models (LLMs), other transformer models, and the like.

The performance of a machine learning model can be evaluated in a number of ways based on the number of true positives, false positives, true negatives, and/or false negatives of the model. For example, consider the case of a model that predicts whether the QoS of a path will satisfy the service level agreement (SLA) of the traffic on that path. In such a case, the false positives of the model may refer to the number of times the model incorrectly predicted that the QoS of a particular network path will not satisfy the SLA of the traffic on that path. Conversely, the false negatives of the model may refer to the number of times the model incorrectly predicted that the QoS of the path would be acceptable. True negatives and positives may refer to the number of times the model correctly predicted acceptable path performance or an SLA violation, respectively. Related to these measurements are the concepts of recall and precision. Generally, recall refers to the ratio of true positives to the sum of true positives and false negatives, which quantifies the sensitivity of the model. Similarly, precision refers to the ratio of true positives the sum of true and false positives.

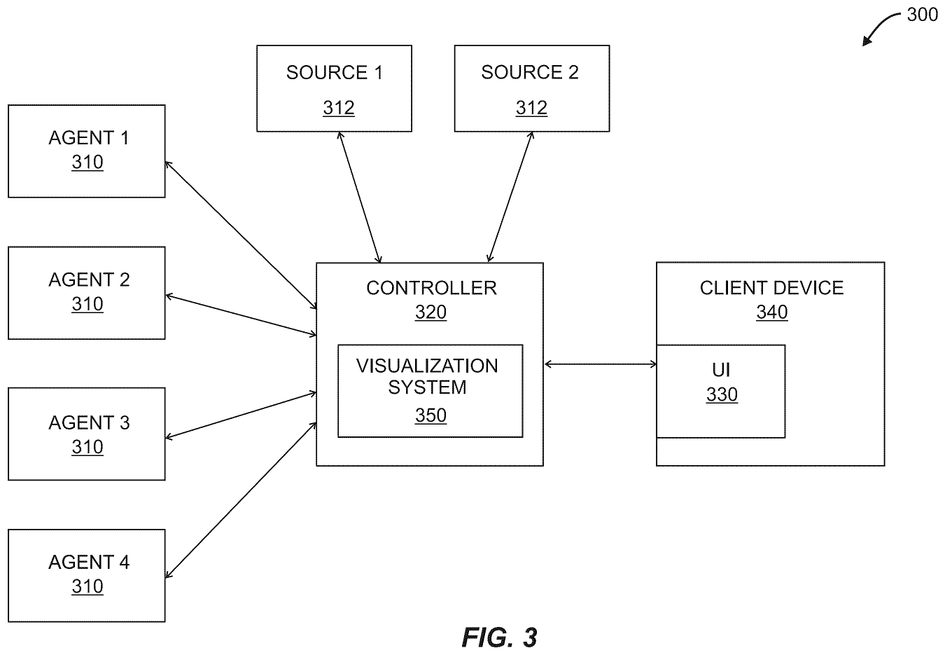

FIG. 3 is a block diagram of an example of an observability intelligence platform 300 that can implement one or more aspects of the techniques herein. The observability intelligence platform is a system that monitors and collects metrics of performance data for a network and/or application environment being monitored. At the simplest structure, the observability intelligence platform includes one or more agents (e.g., agents 310), one or more sources (e.g., sources 312), and one or more servers/controllers (e.g., controller 320). Agents may be installed on network browsers, devices, servers, etc., and may be executed to monitor the associated device and/or application, the operating system of a client, and any other application, API, or another component of the associated device and/or application, and to communicate with (e.g., report data and/or metrics to) the controller 320 as directed. Note that while FIG. 3 shows four agents (e.g., Agent 1 through Agent 4) communicatively linked to a single controller, the total number of agents and controllers can vary based on a number of factors including the number of networks and/or applications monitored, how distributed the network and/or application environment is, the level of monitoring desired, the type of monitoring desired, the level of user experience desired, and so on.

For example, instrumenting an application with agents may allow a controller to monitor performance of the application to determine such things as device metrics (e.g., type, configuration, resource utilization, etc.), network browser navigation timing metrics, browser cookies, application calls and associated pathways and delays, other aspects of code execution, etc. Moreover, if a customer uses agents to run tests, probe packets may be configured to be sent from agents to travel through the Internet, go through many different networks, and so on, such that the monitoring solution gathers all of the associated data (e.g., from returned packets, responses, and so on, or, particularly, a lack thereof). Illustratively, different “active” tests may comprise HTTP tests (e.g., using curl to connect to a server and load the main document served at the target), Page Load tests (e.g., using a browser to load a full page—i.e., the main document along with all other components that are included in the page), or Transaction tests (e.g., same as a Page Load, but also performing multiple tasks/steps within the page—e.g., load a shopping website, log in, search for an item, add it to the shopping cart, etc.).

The controller 320 is the central processing and administration server for the observability intelligence platform. The controller 320 may serve a user interface 330 (denoted UI in FIG. 3), such as a browser-based UI, that is the primary interface for monitoring, analyzing, and troubleshooting the monitored environment. Specifically, the controller 320 can receive data from agents 310, sources 312 (and/or other coordinator devices), associate portions of data (e.g., topology, transaction end-to-end paths and/or metrics, etc.), communicate with agents to configure collection of the data (e.g., the instrumentation/tests to execute), and provide performance data and reporting through user interface 330. User interface 330 may be viewed as a web-based interface viewable by a client device 340. In some implementations, a client device 340 can directly communicate with controller 320 to view an interface for monitoring data. The controller 320 can include a visualization system 350 for displaying the reports and dashboards related to the disclosed technology. In some implementations, the visualization system 350 can be implemented in a separate machine (e.g., a server) different from the one hosting the controller 320.

Notably, in an illustrative Software as a Service (SaaS) implementation, an instance of controller 320 may be hosted remotely by a provider of the observability intelligence platform 300. In an illustrative on-premises (On-Prem) implementation, a controller 320 may be installed locally and self-administered.

The controllers 320 receive data from the agents 310 (e.g., Agents 1-4) and/or sources 312 deployed to monitor networks, applications, databases and database servers, servers, and end user clients for the monitored environment. Any of the agents 310 can be implemented as different types of agents with specific monitoring duties. For example, application agents may be installed on each server that hosts applications to be monitored. Instrumenting an agent adds an application agent into the runtime process of the application. Further, the controllers 320 can receive data from sources 312 (e.g., sources 1-2). Any of the sources can be implemented to provide various types of observability data that can include information, metrics, telemetry data, business data, network data, etc.

Database agents, for example, may be software (e.g., a Java program) installed on a machine that has network access to the monitored databases and the controller. Standalone machine agents, on the other hand, may be standalone programs (e.g., standalone Java programs) that collect hardware-related performance statistics from the servers (or other suitable devices) in the monitored environment. The standalone machine agents can be deployed on machines that host application servers, database servers, messaging servers, Web servers, etc. Furthermore, end user monitoring (EUM) may be performed using browser agents and mobile agents to provide performance information from the point of view of the client, such as a web browser or a mobile native application. Through EUM, web use, mobile use, or combinations thereof (e.g., by real users or synthetic agents) can be monitored based on the monitoring needs.

Note that monitoring through browser agents and mobile agents are generally unlike monitoring through application agents, database agents, and standalone machine agents that are on the server. In particular, browser agents may generally be implemented as small files using web-based technologies, such as JavaScript agents injected into each instrumented web page (e.g., as close to the top as possible) as the web page is served and are configured to collect data. Once the web page has completed loading, the collected data may be bundled into a beacon and sent to an EUM process/cloud for processing and made ready for retrieval by the controller. Browser real user monitoring (Browser RUM) provides insights into the performance of a web application from the point of view of a real or synthetic end user. For example, Browser RUM can determine how specific Ajax or iframe calls are slowing down page load time and how server performance impact end user experience in aggregate or in individual cases. A mobile agent, on the other hand, may be a small piece of highly performant code that gets added to the source of the mobile application. Mobile RUM provides information on the native mobile application (e.g., iOS or Android applications) as the end users actually use the mobile application. Mobile RUM provides visibility into the functioning of the mobile application itself and the mobile application's interaction with the network used and any server-side applications with which the mobile application communicates.

Note further that in certain implementations, in the application intelligence model, a transaction represents a particular service provided by the monitored environment. For example, in an e-commerce application, particular real-world services can include a user logging in, searching for items, or adding items to the cart. In a content portal, particular real-world services can include user requests for content such as sports, business, or entertainment news. In a stock trading application, particular real-world services can include operations such as receiving a stock quote, buying, or selling stocks.

An application transaction, in particular, is a representation of the particular service provided by the monitored environment that provides a view on performance data in the context of the various tiers that participate in processing a particular request. That is, an application transaction, which may be identified by a unique application transaction identification (ID), represents the end-to-end processing path used to fulfill a service request in the monitored environment (e.g., adding items to a shopping cart, storing information in a database, purchasing an item online, etc.). Thus, an application transaction is a type of user-initiated action in the monitored environment defined by an entry point and a processing path across application servers, databases, and potentially many other infrastructure components. Each instance of an application transaction is an execution of that transaction in response to a particular user request (e.g., a socket call, illustratively associated with the TCP layer). An application transaction can be created by detecting incoming requests at an entry point and tracking the activity associated with request at the originating tier and across distributed components in the application environment (e.g., associating the application transaction with a 4-tuple of a source IP address, source port, destination IP address, and destination port). A flow map can be generated for an application transaction that shows the touch points for the application transaction in the application environment. In one implementation, a specific tag may be added to packets by application specific agents for identifying application transactions (e.g., a custom header field attached to a hypertext transfer protocol (HTTP) payload by an application agent, or by a network agent when an application makes a remote socket call), such that packets can be examined by network agents to identify the application transaction identifier (ID) (e.g., a Globally Unique Identifier (GUID) or Universally Unique Identifier (UUID)). Performance monitoring can be oriented by application transaction to focus on the performance of the services in the application environment from the perspective of end users. Performance monitoring based on application transactions can provide information on whether a service is available (e.g., users can log in, check out, or view their data), response times for users, and the cause of problems when the problems occur.

In accordance with certain implementations, both self-learned baselines and configurable thresholds may be used to help identify network and/or application issues. A complex distributed application, for example, has a large number of performance metrics and each metric is important in one or more contexts. In such environments, it is difficult to determine the values or ranges that are normal for a particular metric; set meaningful thresholds on which to base and receive relevant alerts; and determine what is a “normal” metric when the application or infrastructure undergoes change. For these reasons, the disclosed observability intelligence platform can perform anomaly detection based on dynamic baselines or thresholds, such as through various machine learning techniques, as may be appreciated by those skilled in the art. For example, the illustrative observability intelligence platform herein may automatically calculate dynamic baselines for the monitored metrics, defining what is “normal” for each metric based on actual usage. The observability intelligence platform may then use these baselines to identify subsequent metrics whose values fall out of this normal range.

In general, data/metrics collected relate to the topology and/or overall performance of the network and/or application (or application transaction) or associated infrastructure, such as, e.g., load, average response time, error rate, percentage CPU busy, percentage of memory used, etc. The controller UI can thus be used to view all of the data/metrics that the agents report to the controller, as topologies, heatmaps, graphs, lists, and so on. Illustratively, data/metrics can be accessed programmatically using a Representational State Transfer (REST) API (e.g., that returns either the JavaScript Object Notation (JSON) or the eXtensible Markup Language (XML) format). Also, the REST API can be used to query and manipulate the overall observability environment.

Those skilled in the art will appreciate that other configurations of observability intelligence may be used in accordance with certain aspects of the techniques herein, and that other types of agents, instrumentations, tests, controllers, and so on may be used to collect data and/or metrics of the network(s) and/or application(s) herein. Also, while the description illustrates certain configurations, communication links, network devices, and so on, it is expressly contemplated that various processes may be implemented across multiple devices, on different devices, utilizing additional devices, and so on, and the views shown herein are merely simplified examples that are not meant to be limiting to the scope of the present disclosure.

As noted above, there are no existing mechanism capable of monitoring CDN performance. This translates to an inability to identify cache inefficiencies leading to unnecessary latency, an inability to identify geographic load imbalances causing server overloads, unresolved routing inefficiencies increasing round-trip times, inadequate fault isolation hampering problem identification/resolution, inconsistent user experiences frustrating endpoint users, and/or persistent security vulnerabilities and/or exploitations. CDN operators may embed some data in their deliveries'contents for users to debug. However, given the limited scope of users, only very limited performance information can be gathered.

### Quality-of-Service Monitoring in Content Distribution Networks

In contrast, the techniques described herein introduce a mechanism to identify and/or monitor CDN performance by extracting important performance hints hidden in the data in the CDN deliveries'headers. Further, aided with global distributed probes, these techniques may be leveraged to provide an omniscient view of the CDN's performance. For example, for an origin (e.g., content provider), the spanning of its resource on different servers of the CDN provider could be shown, along with the cache information. These insights may be leveraged by users to not only understand how their web pages get delivered to their customers through different CDN networks, and the underlying CDN infrastructure usage, but also to identify and resolve inefficiency or potential issues of their delivery network.

Illustratively, the techniques described herein may be performed by hardware, software, and/or firmware, such as in accordance with CDN monitoring process 248, which may include computer executable instructions executed by the processor 220 (or independent processor of interfaces 210) to perform functions relating to the techniques described herein.

Specifically, according to various implementations, a device may make a determination that a response to a network test probe includes content from a node of a content delivery network. The device extracts, based on the determination, performance data for the content delivery network from a header and from side-channel data collected associated with the response. The device generates, based on the performance data, a performance characterization for the content delivery network. The device provides the performance characterization for the content delivery network to a user interface for review.

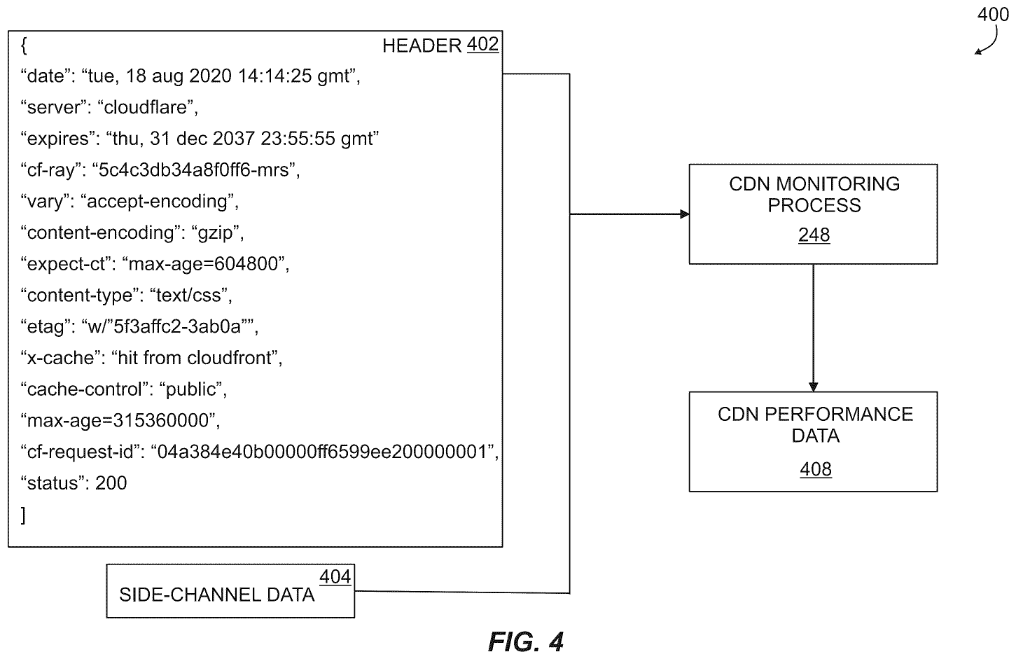

Operationally, FIG. 4 illustrates an example of an architecture 400 for quality-of-service (QoS) monitoring in content distribution networks (CDNs). At the center of this architecture 400 may be CDN monitoring process 248. CDN monitoring process 248 may be utilized to identify, collect, and/or analyze the performance of CDN systems. The CDN monitoring process 248 may output CDN performance data 408 characterizing this performance. The CDN performance data 408 may be generated based on performance hints extracted from data (e.g., header 402, side-channel data 404, etc.) associated with observability intelligence platform testing of CDN servers. CDN monitoring process 248 may utilize the geographical/network spanning of existing observability intelligence platforms (e.g., distributed monitoring infrastructures such as ThousandEyes' agents), and CDN performance hints that can be extracted from data embedded in those CDNs' delivered content (i.e., web pages and headers).

For example, content delivered utilizing a CDN in response to an observability intelligence platform (e.g., ThousandEyes) probe may include a header 402 (e.g., an HTTP header). The header 402 may include a variety of data. This data may be utilized by CDN monitoring process 248 to determine if content served in response to a probe is served from a CDN server and/or to generate CDN performance data 408 (e.g., performance metrics, operational mapping, infrastructure mapping, caching efficiency analysis, security analysis, debugging, identification of delivery network inefficiencies or other potential issues and their resolutions, endpoint user QoS analysis, etc.).

For instance, header 402 may include date data identifying a date and time when the response was generates by the server which may be utilized by CDN monitoring process 248 to determine what content was served, which can be utilized to calculate response times and/or determine load patterns. Header 402 may include server data identifying the server software handling the request, which may be utilized by CDN monitoring process 248 to determine the CDN provider serving the content and/or to conduct performance comparisons across different CDN providers. Header 402 may include expires data specifying the date and time after which the response is considered stale, which may be utilized by CDN monitoring process 248 to develop an understanding of a caching policy and/or content freshness.

In various implementations, header 402 may include cache-control data that identifies directives for caching mechanisms in both browsers and CDNs, which may be utilized by CDN monitoring process 248 to determinable cache-ability and maximum cache times. Header 402 may include “x-cache” data that indicates whether the response was served from the cache, which may be utilized by CDN monitoring process 248 to determine cache hits and/or cache effectiveness. Header 402 may include “vary data” indicating that the response varies based on the accept-encoding header in the request, which may be utilized by CDN monitoring process 248 to develop an understanding of how content negotiation is handled, which can affect performance. Additionally, header 402 may include “content encoding data” specifying the type of encoding used on the response data, which may be utilized by CDN monitoring process 248 to understand and/or identify the utilization of compressed data and/or other mechanisms that reduce load time and bandwidth utilization.

In some instance, header 402 may include “expect-ct data” specifying how long browsers should enforce certificate transparency and where to report violators, which may be utilized by CDN monitoring process 248 to understand and ensure security enhancements and trusted certificate utilization. Header 402 may include “content-type data” indicating the MIME type of the response content, may be utilized by CDN monitoring process 248 to identify and understand the nature of response content and conduct performance analysis of different content types. In addition, header 402 may include “age data” indicating the time since the response was generated, which may be utilized by CDN monitoring process 248 to identify the freshness of content and/or caching efficiency. Header 402 may also include “x-request-id data” indicating a unique identifier for the request, which may be utilized by CDN monitoring process 248 to trace and/or debug specific requests across the system. Header 402 may include “status data” identifying an HTTP status code indicating the result of the request, which may be utilized by CDN monitoring process 248 to identify successes, errors, redirects, etc.

In various implementations, CDN monitoring process 248 may utilize side-channel data 404 to determine if content served in response to a probe is served from a CDN server and/or to generate CDN performance data 408. Side-channel data 404 may include data that is indirectly observed in association with the communication process (e.g., probe and/or response) and not necessarily directly included in the main payload of the response. This may include data that is based on the header data and/or payload data but is an inference rather than a direct extraction from these data sources. Side-channel data 404 may include various metadata and timing information that can be utilized to generate insights about the underlying system's behavior.

For instance, side-channel data 404 may include timing information such as round-trip time which may indicate network latency, server load, etc. Side-channel data 404 may include time to first byte which can help identify server processing delays. Side-channel data 404 may include network path data such as trace route information that may be utilized to identify network bottlenecks or routing issues. Side-channel data 404 nay include resource utilization data such as CPU and memory utilization as inferred from response times and server behavior under load. Side-channel data 404 may include load distribution data indicative of the geographic distribution of locations from which requests are served and which may be inferred from IP addresses and routing data, indicating how well the load is distributed across a CDN's infrastructure, etc.

That is, CDN monitoring process 248 may be utilized in the analysis and detection of important signals, e.g., HTTP headers, server IPs, and related ASN information, which could be extracted from CDNs' deliveries to observability intelligence platform agents in their HTTP testing. CDN monitoring process 248 may later combine the result from the observability intelligence platform agents in different networks and/or locations to produce CDN performance data 408 such as a performance overview of one specific CDN and even for a specific domain (e.g., customer).

Existing CDN performance monitoring systems focus on network-level performance information collected by ping and traceroute. Moreover, those systems usually are built with the CDN provider's own servers. The performance information collected by this kind of infrastructure can be very limited (e.g., only latency information could be collected, any high-level information is neglected, internal access may behave very differently from public access, etc.)

In contrast, CDN monitoring process 248 may be utilized to detect if one specific content/resource that appeared in an observability intelligence platform's HTTP test is served from a CDN server. Among these HTTP requests that come from CDN servers, performance hints (i.e., server location, cache status, round trip time, etc.) could be extracted from the side-channel paddings (e.g., side-channel data 404).

Based on the performance information extracted from the distributed observability intelligence platform agents that covered diverse networks and geographic locations, CDN monitoring process 248 may monitor CDN health and performance and generate CDN performance data 408 characterization thereof. For example, CDN monitoring process 248 may monitor and/or report on CDN health and performance by building up baselines on the collected metrics (e.g., cache miss rate, round trip time, etc.) and detecting deviations from norm. CDN monitoring process 248 may also synthesize the result from other sources in the measurement suite (e.g., ping, traceroute, BGP, HTTP, etc.) to conduct complex root cause analysis. CDN monitoring process 248 may also be utilized to identify CDN deficiencies and/or resolutions since observed CDN deficiencies could be caused by network-layer (e.g., network queening during traffic peak) or even BGP-layer (e.g., BGP drop) anomaly or even outage.

The CDN performance data 408 resulting from CDN monitoring process 248 may provide useful and actionable overviews and insights to not only endpoint users, but also to origin servers. For example, the CDN performance data 408 may be utilized to identify and/or analyze complex CDN deficiency issues, such as what will happen if one specific CDN's server is offline, whether one specific resource of one domain usually gets evicted from the CDN's server even though the endpoint user usually got to the nearest server location, etc.

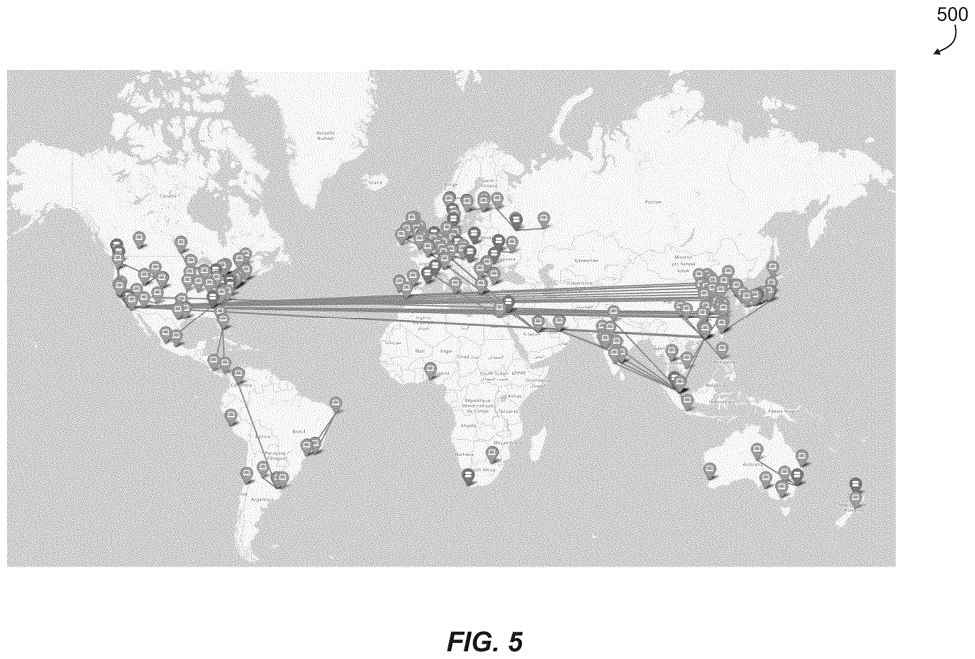

FIG. 5 illustrates an example of a mapping 500 of observability intelligence platform agents and the CDN server locations discovered by the observability intelligence platform agents through probing. Mapping 500 may be an example of CDN performance data generated by CDN monitoring process. The mapping 500 illustrates the ability of the CDN monitoring process to detect and the physical network topology of the CDN infrastructure, providing insights into server distribution, geographic load balancing, and routing efficiencies. Mapping 500 may be utilized to identify potential performance bottlenecks, optimize content delivery routes, and improve overall CDN performance.

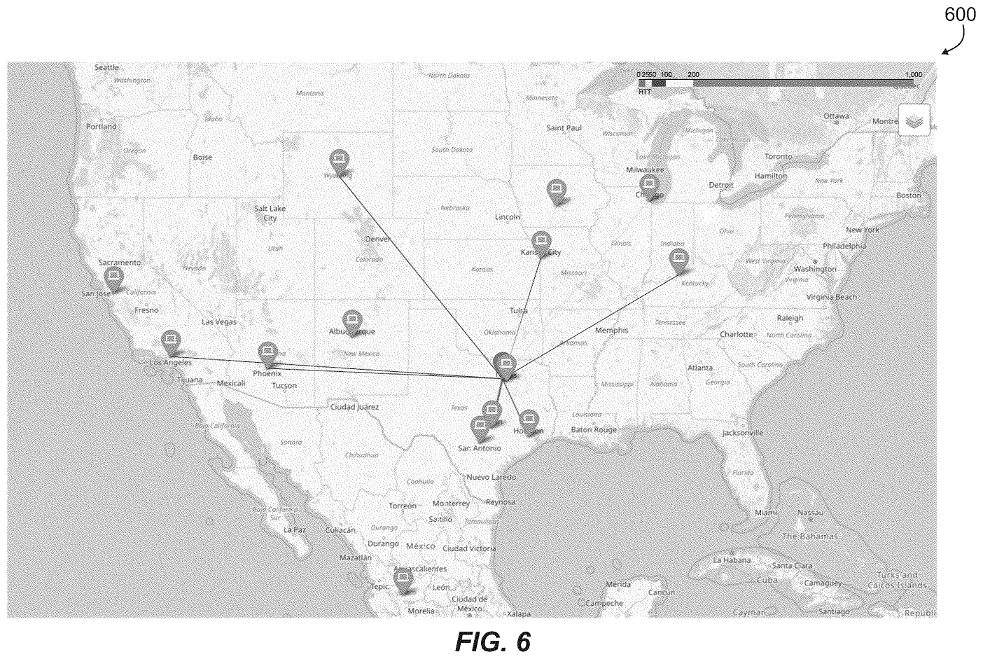

FIG. 6 illustrates an example of a performance mapping 600 of observability intelligence platform agents downloading web pages from a particular CDN server. Performance mapping 600 may be an example of CDN performance data generated by CDN monitoring process.

Performance mapping 600 provides a round-trip time (RTT) performance graded mapping of the interactions between observability intelligence platform monitoring agents and a CDN server located in Dallas, Texas. The performance mapping 600 provides the geographic distribution of various observability intelligence platform monitoring agent engaged in downloading web pages from the Dallas-based CDN server, visualized by the lines connecting the agents to the server. The lines are visually coded to represent the RTT for each connection, providing a clear visual indication of the latency experienced by different agents.

This visualization may effectively demonstrate the performance and efficiency of the CDN server from different geographical locations. By analyzing the visually coded RTT data, one can easily identify regions with optimal performance and those experiencing latency issues. This information may be crucial for optimizing content delivery, improving user experience, and ensuring that the CDN infrastructure operates efficiently.

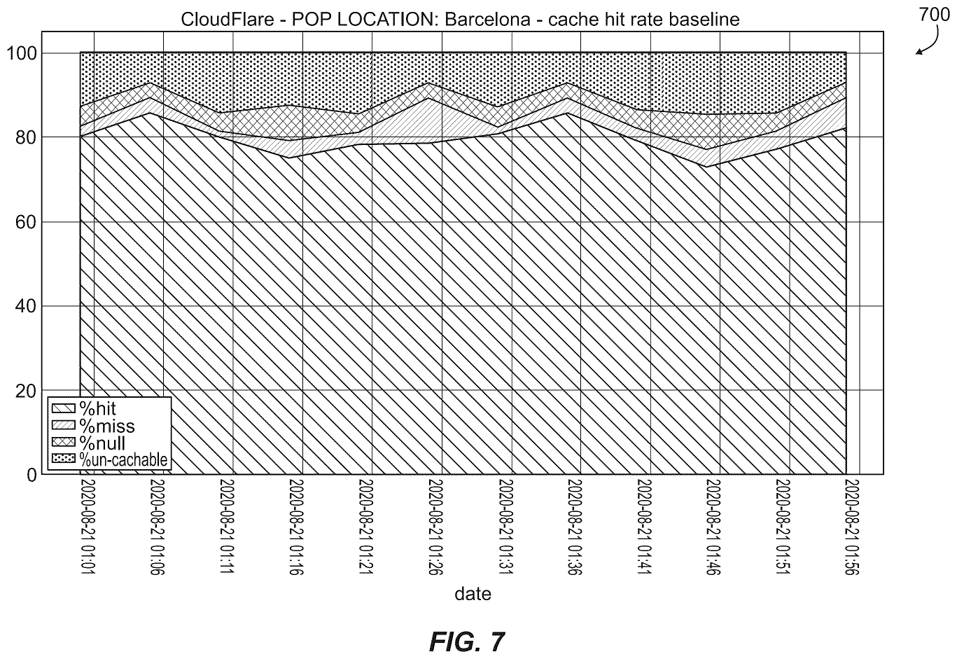

FIG. 7 illustrates an example of a cache hit rate graph 700. The cache hit rate graph 700 may be an example of CDN performance data generated by CDN monitoring process. The cache hit rate graph 700 may illustrate the cache hit rate of a CDN server located in Barcelona. The cache hit rate graph 700 may be a graphical representation of the server's caching performance over a specified period.

For example, the vertical (Y-axis) of cache hit rate graph 700 may represent the cache hit rate percentage, indicating the proportion of content requests served directly from the cache without needing to fetch from the origin server. The horizontal axis (X-axis) may represent time, segmented into appropriate intervals (e.g., minutes, hours, days, etc.).

Cache hit rate graph 700 may feature a line plot or bar chart that depicts the fluctuations in cache hit rate throughout the monitoring period. This visualization may provide an understanding of the caching behavior and efficiency of the CDN server in Barcelona. A high cache hit rate may signify efficient content delivery with minimal latency, while a low hit rate may indicate potential issues with cache management or content distribution strategies. By analyzing this graph, stakeholders may be able to identify patterns, diagnose performance bottlenecks, and implement optimizations to enhance the overall effectiveness of the CDN infrastructure.

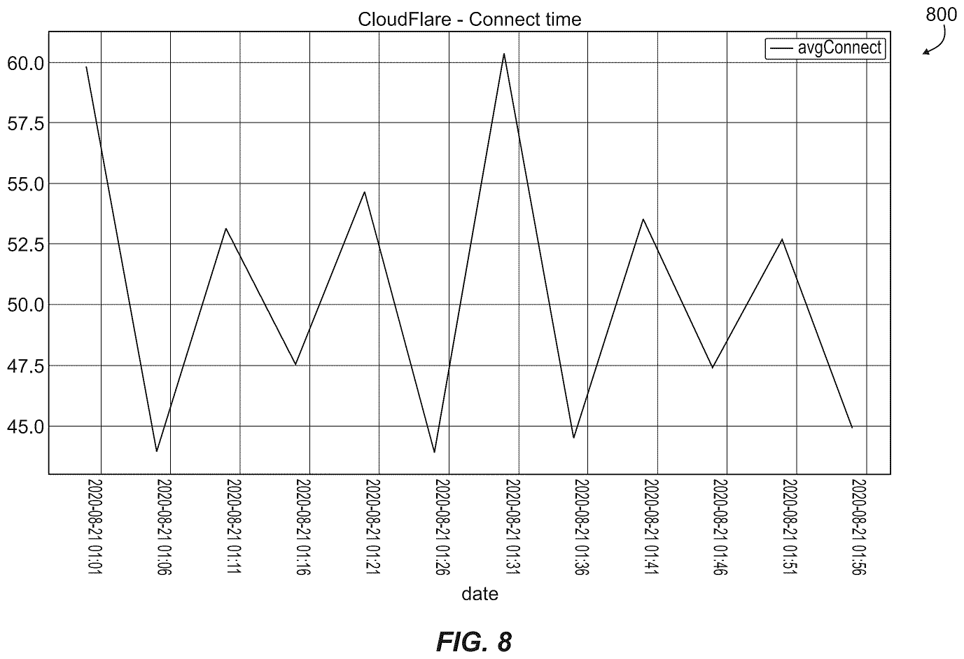

FIG. 8 illustrates an example of an RTT graph 800 for a CDN server. RTT graph 800 may be an example of CDN performance data generated by CDN monitoring process. The RTT graph 800 may provide a detailed analysis of the server's latency performance over a specified monitoring period.

The vertical axis (Y-axis) of RTT graph 800 may represent the RTT (e.g., in milliseconds), indicating the time it takes for a data packet to travel from the monitoring agent to the CDN server and back. The horizontal axis (X-axis) represents time, segmented into appropriate intervals (e.g., minutes, hours, days, etc.).

RTT graph 800 may provide an understanding of the latency performance of a particular CDN server. Low RTT values may suggest efficient and fast content delivery, while high RTT values may indicate network issues, server overloads, suboptimal routing paths, etc. By analyzing this graph, stakeholders can identify latency trends, diagnose performance bottlenecks, and/or implement strategies to optimize the CDN's responsiveness and reliability.

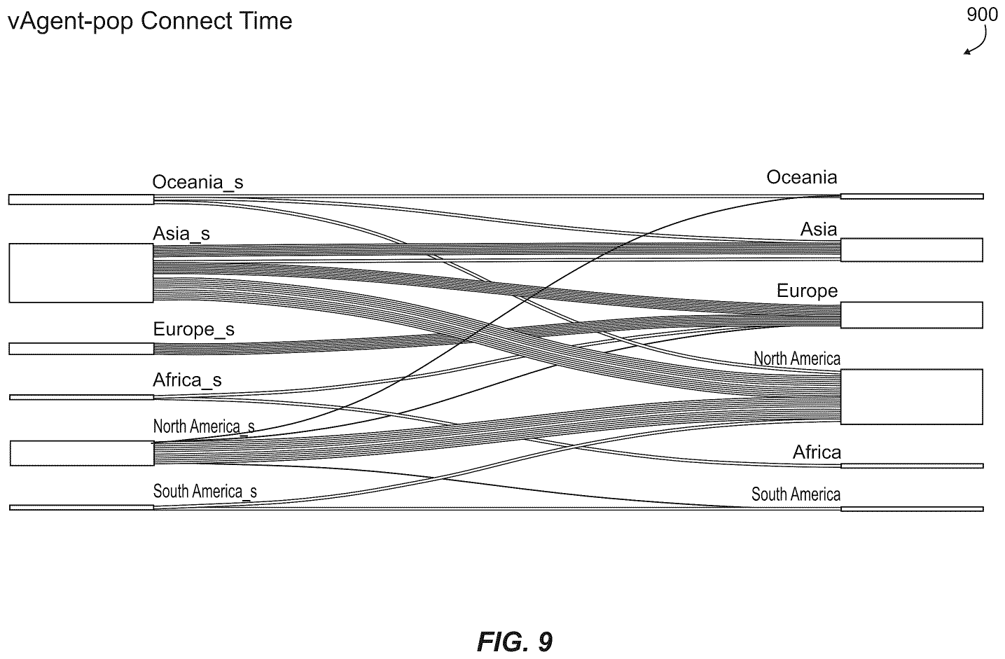

FIG. 9 illustrates an example of an agent-CDN server access geographical distribution chart 900. The agent-CDN server access geographical distribution chart 900 may be an example of CDN performance data generated by CDN monitoring process. The agent-CDN server access geographical distribution chart 900 provides the geographical distribution of connection times between monitoring agents and CDN servers across various regions. The agent-CDN server access geographical distribution chart 900 may be visually coded to represent different connect times experienced by a variety of geographic regions.

This visualization may be leveraged to identify the performance and efficiency of CDN connections from different geographical regions. It may highlight areas with optimal connection times and regions where performance improvements may be needed. Leveraging the agent-CDN server access geographical distribution chart 900, stakeholders may be able to optimize server placements, enhance network routing, and ensure efficient content delivery across a variety of geographic regions.

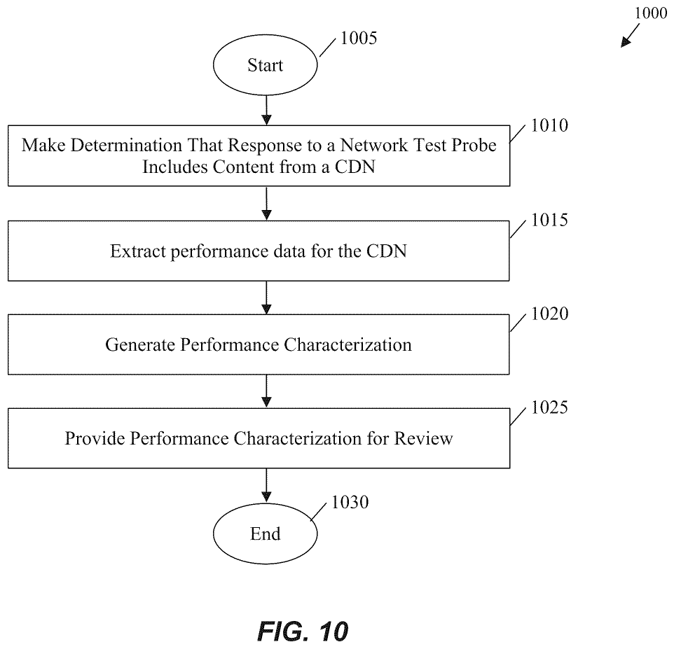

FIG. 10 illustrates an example of a simplified procedure for quality-of-service monitoring in content distribution networks, in accordance with one or more implementations described herein. For example, a non-generic, specifically configured device (e.g., device 200), may perform procedure 1000 (e.g., a method) by executing stored instructions (e.g., CDN monitoring process 248). The procedure 1000 may start at step 1005, and continues to step 1010, where, as described in greater detail above, the device (e.g., a controller, processor, etc.) may make a determination that a response to a network test probe includes content from a node of a content delivery network.

At step 1015, as detailed above, the device may extract performance data for the content delivery network from a header and from side-channel data collected associated with the response. The performance data extracted from the header may include a location of the node of the content delivery network. The performance data may include a cache status associated with the response to the network test probe. The side-channel data may include a round-trip time associated with the response to the network test probe.

At step 1020, the device may generate, based on the performance data, a performance characterization for the content delivery network. Generating the performance characterization may include building a baseline of collected metrics for the content delivery network and identifying deviations from the baseline in the performance characterization. The collected metrics may include cache miss rates.

In various implementations, generating the performance characterization may include integrating the performance data with network-level diagnostic data. The network-level diagnostic data may include one or more of ping testing data, traceroute data, or border gateway protocol data.

Generating the performance characterization may include performing root cause analysis of problems in the content delivery network. In addition, generating the performance characterization may include generating a mapping of the content delivery network.

At step 1025, the device may provide the performance characterization for the content delivery network via a user interface. Root cause analysis may be provided as part of the performance characterization. Further, a mapping of the content delivery network may be provided as part of the performance characterization.

Procedure 1000 then ends at step 1030.

It should be noted that while certain steps within procedure 1000 may be optional as described above, the steps shown in FIG. 10 are merely examples for illustration, and certain other steps may be included or excluded as desired. Further, while a particular order of the steps is shown, this ordering is merely illustrative, and any suitable arrangement of the steps may be utilized without departing from the scope of the implementations herein.

The techniques described herein, therefore, introduce a mechanism to identify and/or monitor CDN performance by extracting important performance hints hidden in the data in the CDN deliveries' headers. Further, aided with global distributed probes, these techniques may be leveraged to provide an omniscient view of the CDN's performance. For example, for an origin (e.g., content provider), the spanning of its resource on different servers of the CDN provider could be shown, along with the cache information. These insights may be leveraged by users to not only understand how their web pages get delivered to their customers through different CDN networks, and the underlying CDN infrastructure usage, but also to identify and resolve inefficiency or potential issues of their delivery network.

While there have been shown and described illustrative implementations that provide for quality-of-service monitoring in content distribution networks, it is to be understood that various other adaptations and modifications may be made within the intent and scope of the implementations herein. In addition, while certain processes are shown, other suitable processes may be used, accordingly.

The foregoing description has been directed to specific implementations. It will be apparent, however, that other variations and modifications may be made to the described implementations, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the implementations herein. Therefore, it is the object of the appended claims to cover all such variations and modifications as come within the true spirit and scope of the implementations herein.

1. A method, comprising:
making, by a device, a determination that a response to a network test probe includes content from a node of a content delivery network;
extracting, by the device and based on the determination, performance data for the content delivery network from a header and from side-channel data collected associated with the response;
generating, by the device and based on the performance data, a performance characterization for the content delivery network; and
providing, by the device, the performance characterization for the content delivery network to a user interface for review.

2. The method as in claim 1, wherein the performance data extracted from the header includes a location of the node of the content delivery network.

3. The method as in claim 1, wherein the performance data includes a cache status associated with the response to the network test probe.

4. The method as in claim 1, wherein generating the performance characterization includes: building a baseline of collected metrics for the content delivery network; and identifying deviations from the baseline in the performance characterization.

5. The method as in claim 4, wherein the collected metrics include cache miss rates.

6. The method as in claim 1, wherein the side-channel data includes a round-trip time associated with the network test probe.

7. The method as in claim 1, wherein generating the performance characterization includes integrating the performance data with network-level diagnostic data.

8. The method as in claim 7, wherein the network-level diagnostic data includes one or more of ping testing data, traceroute data, or border gateway protocol data.

9. The method as in claim 1, wherein generating the performance characterization includes: performing root cause analysis of problems in the content delivery network; and providing the root cause analysis as part of the performance characterization.

10. The method as in claim 1, wherein generating the performance characterization includes: generating a mapping of the content delivery network; and providing the mapping as part of the performance characterization.

11. An apparatus, comprising:
one or more network interfaces;
a processor coupled to the one or more network interfaces and configured to execute one or more processes; and
a memory configured to store a process that is executable by the processor, the process when executed configured to:
make a determination that a response to a network test probe includes content from a node of a content delivery network;
extract, based on the determination, performance data for the content delivery network from a header and from side-channel data collected associated with the response;
generate, based on the performance data, a performance characterization for the content delivery network; and
provide the performance characterization for the content delivery network to a user interface for review.

12. The apparatus as in claim 11, wherein the performance data extracted from the header includes a location of the node of the content delivery network.

13. The apparatus as in claim 11, wherein the performance data includes a cache status associated with the response to the network test probe.

14. The apparatus as in claim 11, wherein generating the performance characterization includes building a baseline of collected metrics for the content delivery network and identifying deviations from the baseline in the performance characterization.

15. The apparatus as in claim 14, wherein the collected metrics include cache miss rates.

16. The apparatus as in claim 11, wherein the side-channel data includes a round-trip time associated with the response to the network test probe.

17. The apparatus as in claim 11, wherein generating the performance characterization includes integrating the performance data with network-level diagnostic data and wherein the network-level diagnostic data includes one or more of ping testing data, traceroute data, or border gateway protocol data.

18. The apparatus as in claim 11, wherein generating the performance characterization includes performing root cause analysis of problems in the content delivery network and providing the root cause analysis as part of the performance characterization.

19. The apparatus as in claim 11, wherein generating the performance characterization includes generating a mapping of the content delivery network and providing the mapping as part of the performance characterization.

20. A tangible, non-transitory, computer-readable medium storing program instructions that cause a device to execute a process comprising:
making, by the device, a determination that a response to a network test probe includes content from a node of a content delivery network;
extracting, by the device and based on the determination, performance data for the content delivery network from a header and from side-channel data collected associated with the response;
generating, by the device and based on the performance data, a performance characterization for the content delivery network; and
providing, by the device, the performance characterization for the content delivery network to a user interface for review.
